(19) United States
(12) Patent Application Publication
(10) Pub. No.: US 2023/0032413 A1
(43) Pub. Date: Feb. 2, 2023

(54) IMAGE CLASSIFIER WITH LESSER REQUIREMENT FOR LABELLED TRAINING DATA

(71) Applicant: Robert Bosch GmbH, Stuttgart (DE)

(72) Inventors: Piyapat Saranrittichai, Nuernberg (DE); Andres Mauricio Munoz Delgado, Weil Der Stadt (DE); Chaithanya Kumar Mummadi, Pittsburgh, PA (US); Claudia Blaiotta, Stuttgart (DE); Volker Fischer, Renningen (DE)

(21) Appl. No.: 17/861,440

(22) Filed: Jul. 11, 2022

(30) Foreign Application Priority Data
Jul. 28, 2021 (DE) 10 2021 208 156.8

(51) Int. Cl. G06V 10/774; G06V 10/764; G06V 10/82; G06V 10/776; G06V 20/56

(52) U.S. Cl. CPC G06V 10/774; G06V 10/764; G06V 10/82; G06V 10/776; G06V 20/56; G06V 10/56

(57) ABSTRACT

An image classifier for classifying an input image x with respect to combinations of an object value o and an attribute value. The image classifier includes an encoder network that is configured to map the input image to a representation comprising multiple independent components; an object classification head network configured to map representation components of the input image to one or more object values; an attribute classification head network configured to map representation components of the input image to one or more attribute values; and an association unit configured to provide, to each classification head network, a linear combination of those representation components of the input image x that are relevant for the classification task of the respective classification head network. A method for training the image classifier is also provided.

### CROSS REFERENCE

The present application claims the benefit under 35 U.S.C. § 119 of German Patent Application No. DE 10 2021 208 156.8 filed on Jul. 28, 2021, which is expressly incorporated herein by reference in its entirety.

### FIELD

The present invention relates to image classifiers that may, inter alia, be used to analyze images of traffic situations for the purpose of at least partially automated driving.

### BACKGROUND INFORMATION

Observation of the environment of a vehicle is the primary source of information that a human driver uses when steering a vehicle through traffic. Consequently, systems for the at least partially automated driving also rely on the analysis of images of the vehicle's environment. This analysis is performed using image classifiers that detect object-attribute pairs in the acquired images. For example, an object may be of a certain type (such as traffic sign, vehicle, lane) and also be given an attribute that refers to a certain property or state of the object (like a color). Such image classifiers are trained with training images that are labelled with ground truth as to their object content.

For reliable operation of the image classifier, training with a broad set of images acquired in a wide variety of situations is necessary, so that the image classifier can optimally generalize to unseen situations.

### SUMMARY

The present invention provides an image classifier for classifying an input image x with respect to combinations y=(a, o) of an object value o and an attribute value a.

In accordance with an example embodiment of the present invention, the image classifier comprises an encoder network that is configured to map the input image x to a representation Z, wherein this representation Z comprises multiple independent components z₁, . . . , z_{K}. For example, this encoder network may comprise one or more convolutional layers that apply filter kernels to the input image and produce one or more feature maps.

The image classifier further comprises an object classification head network that is configured to map representation components z₁, . . . , z_{K} of the input image x to one or more object values o, as well as an attribute classification head network that is configured to map representation components z₁, . . . , z_{K} of the input image x to one or more attribute values a. But these classification head networks are not getting the complete representation Z with all representation components z₁, . . . , z_{K} as input. Rather, the image classifier comprises an association unit that is configured to provide, to each classification head network, a linear combination zₒ, zₐ of those representation components z₁, . . . , z_{K} of the input image x that are relevant for the classification task of the respective classification head network.

By restricting access of each classification head network to particular representation components z₁, . . . , z_{K} of the input image x, a tendency of the image classifier to learn unwanted associations during training is reduced.

For example, if the training images contain fire trucks with their distinctive red color, the image classifier may associate the object type “fire truck” not only with the shape of a fire truck, but also with the color “red”. In particular, because it is much easier for the image classifier to determine that the image contains much red than it is to discriminate between different shapes of vehicles, the image classifier may rely more on the color than on the shape. Such “shortcut learning” may fail to generalize to images that are not in the distribution of the training images. For example, some airport fire trucks are yellow. Because yellow is in turn the color that many school buses have, and both are vehicles with a rather large silhouette, an image classifier that has succumbed to “shortcut learning” might misclassify the yellow fire truck as a school bus.

It is the job of the association unit to prevent this behavior. If it is known in advance that the shape of a vehicle is much more important and discriminative for determining the type of vehicle than the color, the association unit may pass on the representation components z₁, . . . , z_{K} of the input image x that relate to the shape of the object to the object classification head network, while keeping the color of the object hidden from this object classification head network. During training, the object head classification network can then only work with the information it gets, and has no other choice than to learn how to discriminate between types of vehicles by shape.

This in turn allows to train the image classifier with less combinations of image properties, which in turn causes a lesser amount of training images to be required. To teach the image classifier that not all fire trucks are red, no training images that contain fire trucks of different colors are required. To overcome the “shortcut learning” just by supplying more training images that contradict this “shortcut learning” may be difficult. In the example of fire trucks, the vast majority of them are red, and an extra effort is required to deliberately procure images that show fire trucks of other colors. This effort can now be saved.

The effect is most pronounced if the representation Z is factorized into components z₁, . . . , z_{K} that relate to different aspects of the input image x, such that the association unit may choose in a fine-grained manner which information to forward to the classification head networks for which particular task. Therefore, in a particularly advantageous embodiment, the encoder network is trained to produce a representation Z whose components z₁, . . . , z_{K} each contain information related to one predetermined basic factor of the input image x. Examples for such basic factors include:
a shape of at least one object in the image x;
a color of at least one object in the image x and/or area of the image x;
a lighting condition in which the image x was acquired; and
a texture pattern of at least one object in the image x.

The object value o may, for example, designate an object type from a given set of available types. For example, when evaluating images of traffic situations, these types may include traffic signs, other vehicles, obstacles, lane markings, traffic lights or any other traffic-relevant object. As discussed above, examples of attributes a that may be classified and associated with an object value o include the color and the texture of the object. By means of the association unit, color or texture information may be used for the classification of the color or texture, while a “leaking” of this color or texture information to the classification of the object type is prevented.

The mentioned factorization of the representation Z into multiple components z₁, . . . , z_{K} is already advantageous during a conventional training with labelled training images because there is no need for extra images to overcome “shortcut learning”. But this factorization also allows for a new form of training that reduces the need for labelled training images even further.

The present invention therefore also provides a method for training or pre-training the image classifier described above.

In the course of this method, for each component z₁, . . . , z_{K} of the representation Z, a factor classification head network is provided. This factor classification head network is configured to map the respective component z₁, . . . , z_{K} to a predetermined basic factor of the image x.

Furthermore, factor training images are provided. These factor training images are labelled with ground truth values with respect to the basic factors represented by the components z₁, . . . , z_{K}. For example, if the basic factor is color, the corresponding ground truth value for the factor training image is the color of an object shown in this image. As it will be discussed below, the factor training images do not need to be comprised in, or even be similar to, the original labelled training images.

By means of the encoder network and the factor classification head networks, the factor training images are mapped to values of the basic factors. That is, the encoder generates representations Z with components z₁, . . . , z_{K}, and each such component z₁, . . . , z_{K} is then passed on to its respective factor classification head network, to be mapped to the value of the respective basic factor.

Deviations of the so-determined values of the basic factors from the ground truth values are rated by means of a first predetermined loss function. Parameters that characterize the behavior of the encoder network and parameters that characterize the behavior of the factor classification head networks are optimized towards the goal that, when further factor training images are processed, the rating by the first loss function is likely to improve.

In this manner, the encoder network may be specifically trained to produce representations Z that are well factored into components z₁, . . . , z_{K} such that each such component z₁, . . . , z_{K} depends on only one basic factor. The encoder network thus learns the basic skills that it can later use to produce meaningful representations of the actual to-be-processed input images for use by the object classification head networks. For example, after training the encoder network, the classification head networks may be trained in a conventional manner while keeping the parameters of the encoder network fixed.

The training is in some way analogous to the learning of how to play an instrument, such as the piano. First, a set of basic skills is learned using specifically crafted exercises that need not resemble any work of music. After the basic skills have been learned, the training may move on to real works of music. This is a lot easier than directly making the first attempts with the instrument on the real work of music and trying to learn all required skills at the same time.

The factor training images may be obtained from any suitable source. In particular, they do not need to bear any resemblance to the actual input images that the image classifier is being trained to process. In a particularly advantageous embodiment, the providing of factor training images therefore comprises:
applying, to at least one given starting image, image processing that impacts at least one basic factor, thereby producing a factor training image; and
determining the ground truth values with respect to the basic factors based on the applied image processing.

These factor training images are thus comparable to the exercise pieces that are played when learning how to play a musical instrument. They are “cheap” in the sense that they can be generated automatically without any human labelling, whereas the training of the classification head networks requires labelled training images.

In a further particularly advantageous embodiment of the present invention, in each factor training image, each basic factor takes a particular value. The set of factor training images comprises at least one factor training image for each combination of values of the basic factors. In this manner, any unwanted correlations between factors may be broken up during the training of the encoder network. For example, in the set of factor training images, any color may appear in combination with any texture and any object shape.

In a further advantageous embodiment of the present invention, the object classification head network and the attribute classification head network are trained as well.

To this end, classification training images are provided. These classification training images are labelled with ground truth combinations (a*, o*) of object values o* and attribute values a*. By means of the encoder network, the object classification network and the attribute classification head network, the classification training images are mapped to combinations (a, o) of object values o and attribute values a.

That is, the encoder network produces a representation Z of the classification training image. For determining the object value o, the association unit chooses a first subset of the representation components z₁, . . . , z_{K} to pass on to the object classification head network. For determining the attribute value a, the association unit chooses a different subset of the representation components z₁, . . . , z_{K} to pass on to the attribute classification network.

Deviations of the so-determined combinations (a, o) from the respective ground truth combinations (a*, o*) are rated by means of a second predetermined loss function. At least parameters that characterize the behavior of the object classification head network and parameters that characterize the behavior of the attribute classification head network are optimized towards the goal that, when further classification training images are processed, the rating by the second loss function is likely to improve.

As discussed above, because this training can build upon the skill in classifying the basic factors f₁, . . . , f_{K} that the encoder network has already acquired, it can achieve good results with a lesser amount of labelled classification training images.

In a particularly advantageous embodiment of the present invention, combinations of one encoder network on the one hand and multiple different combinations of an object classification head network and an attribute classification head network on the other hand are trained based on one and the same training of the encoder network with factor training images. That is, the training based on the factor training images may be re-used for a different application in a completely different domain of images. This saves time for the training and also facilitates regulatory approval of the image classifier. For example, a regulatory seal of approval may be obtained for the encoder network once it has been trained on the factor training images. After that, if a new use case is to be handled, a new approval is only required for the newly trained object classification head network and the newly trained attribute classification head network.

If the training of the encoder and factor classification networks is performed first, and the training of the object classification head and attribute classification head networks is performed later, the learned state of the encoder network obtained during the training on the factor training images is transferred to the training on the classification training images in the domain of application where the finally trained image classifier is to be used. For this reason, the factor training images may be understood as “source images” in a “source domain”, and the classification training images may be understood as “target images” in a “target domain”. But this is not to be confused with domain transfer using CycleGAN or other generative models.

In a further advantageous embodiment of the present invention, a combined loss function is formed as a weighted sum of the first loss function and the second loss function. The parameters that characterize the behaviors of all networks are optimized with the goal of improving the value of this combined loss function. That is, the encoder network, the factor classification head networks, the object classification head network and the attribute classification head network may all be trained simultaneously. The trainings may then work hand in hand in order to obtain the solution that is optimal with respect to the combined loss function. The first loss function and the second loss function may, for example, be cross-entropy loss functions.

In a further particularly advantageous embodiment of the present invention, the classification training images comprise images of road traffic situations. On top of the actual object content, these images are dependent on so many factors that it is very difficult and expensive to acquire a set of training images with many different combinations of factors. For example, the dataset may contain active construction areas with workers on the road only at daylight times because most construction areas are not active at nighttime. But if such a construction area is active at nighttime, the image classifier should nonetheless recognize it. With the presently proposed training method, the classification may be uncoupled from whether the image was taken during daytime or nighttime because the association unit can withhold the respective component z₁, . . . , z_{K} from the object classification head network, and/or from the attribute classification head network.

In particular, the basic factors that correspond to the components z₁, . . . , z_{K} of the representation Z may comprise one or more of:
a time of day;
lighting conditions;
a season of the year; and
weather conditions
   in which the image x is acquired.

If these basic factors can be withheld from the object classification head network, and/or from the attribute classification head network, the variability among the images in the dataset may be focused more on the actual semantic differences between objects in the training images.

Consequently, fewer training images are needed to achieve a desired level of classification accuracy.

The image classifier and the training method described above may be wholly or partially computer-implemented, and thus embodied in software. The present invention therefore also relates to a computer program, comprising machine-readable instructions that, when executed by one or more computers, cause the one or more computers to implement the image classifier described above, and/or to perform a method described above. In this respect, control units for vehicles and other embedded systems that may run executable program code are to be understood to be computers as well. A non-transitory storage medium, and/or a download product, may comprise the computer program. A download product is an electronic product that may be sold online and transferred over a network for immediate fulfilment. One or more computers may be equipped with said computer program, and/or with said non-transitory storage medium and/or download product.

In the following, the present invention and its preferred embodiments are illustrated using Figures without any intention to limit the scope of the present invention.

### BRIEF DESCRIPTION OF THE DRAWING

FIG. 1 shows an exemplary embodiment of the image classifier 1, according to the present invention.

FIG. 2 shows an exemplary embodiment of the training method 100, accordance with the present invention.

### DETAILED DESCRIPTION OF EXAMPLE EMBODIMENTS

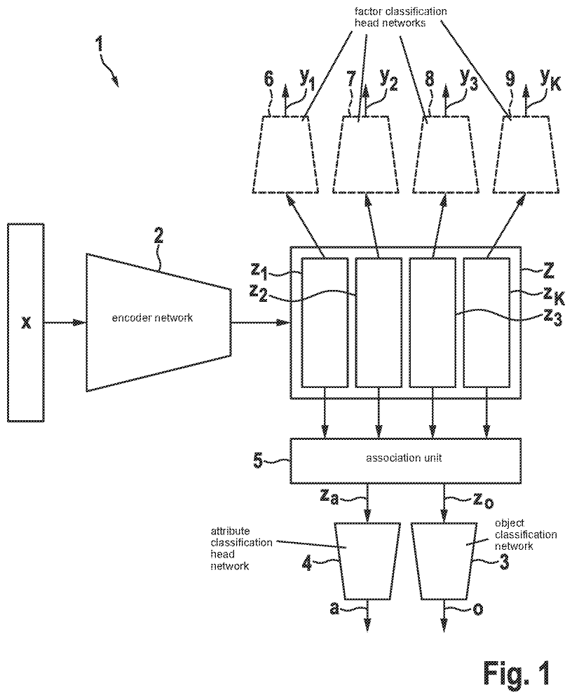

FIG. 1 is a schematic diagram of an exemplary embodiment of the image classifier 1. The image classifier 1 comprises an encoder network 2 that is configured to map an input image x to a representation Z. This representation Z comprises multiple independent components z₁, z₂, z₃, z_{K} that each contain information related to one predetermined basic factor f₁, f₂, f₃, f_{K} of the input image x. Values y₁ y₂, y₃, y_{K} of the respective predetermined basic factor f₁, f₂, f₃, f_{K} can be evaluated from the respective representation component z₁, z₂, z₃, z_{K} by means of a respective factor classification head network 6-9 that is only needed during training of the image classifier 1 and may be discarded once this training is complete. Therefore, the factor classification head networks 6-9 are drawn in dashed lines.

The image classifier 1 further comprises an object classification network 3 that is configured to to map representation components z₁, . . . , z_{K} of the input image x to one or more object values o, as well as an attribute classification head network 4 that is configured to map representation components z₁, . . . , z_{K} of the input image x to one or more attribute values a. An association unit 5 provides, to each classification head network 3, 4, a linear combination z₀, zₐ of those representation components z₁, . . . , z_{K} of the input image x that are relevant for the classification task of the respective classification head network 3, 4. That is, information on which the classification head network 3, 4 should not rely is withheld from that network 3, 4. For example, to prevent that the object classification head network 3 takes a “shortcut” by classifying types of vehicles based on their color rather than on their shape, the representation component z₁, . . . , z_{K} that is indicative of the color may be withheld from the object classification head network 3. In another example, if the attribute classification head network 4 is to determine the color of the object as attribute a, the association unit 5 may withhold the representation component z₁, . . . , z_{K} that is indicative of the shape of the object from this attribute classification head network 4.

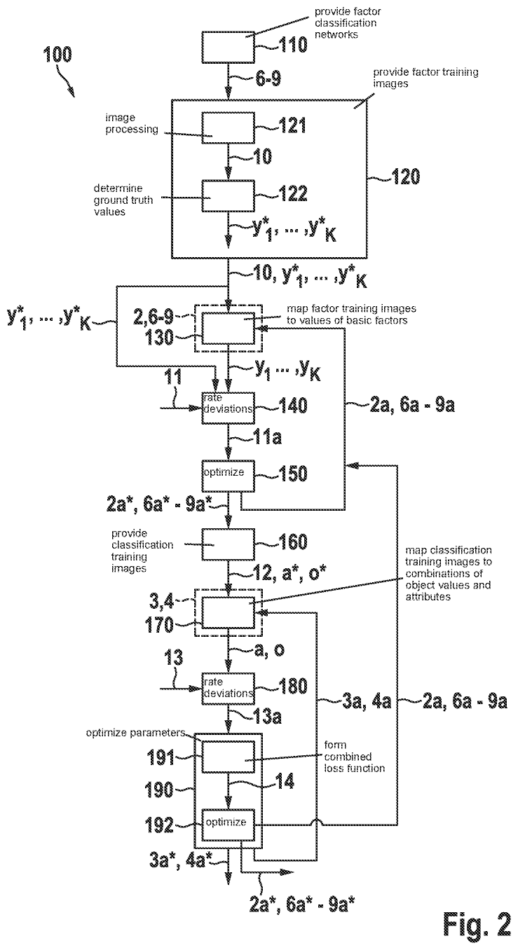

FIG. 2 is a schematic flow chart of the method 100 for training or pre-training the image classifier 1 described above.

In step 110, for each component z₁, . . . , z_{K} of the representation Z, a factor classification head network 6-9 is provided. This factor classification head network 6-9 is configured to map the respective component z₁, . . . , z_{K} to a predetermined basic factor f₁ . . . , f_{K} of the image x.

In step 120, factor training images 10 are provided. These factor training images 10 labelled with ground truth values y₁*, . . . , y_{K}* with respect to the basic factors f₁, . . . , f_{K} represented by the components z₁, . . . , z_{K}.

According to block 121, image processing that impacts at least one basic factor f₁, . . . , f_{K} may be applied to at least one given starting image. This produced a factor training image 10.

According to block 122, the ground truth values y₁*, . . . , y_{K}* with respect to the basic factors f₁, . . . , f_{K} may then be determined based on the applied image processing.

In step 130, the encoder network 2 and the factor classification head networks 6-9 map the factor training images (10) to values y₁, . . . , y_{K} of the basic factors f₁, . . . , f_{K}. Internally, this is done as follows: The encoder network 2 maps the factor training images 10 to representations Z. Each component z₁, z₂, z₃, z_{K} of the representation Z is passed on to the respective factor classification head network 6-9 that then outputs the respective values y₁, . . . , y_{K} of the basic factors f₁, . . . , f_{K}

In step 140, deviations of the so-determined values y₁, . . . , y_{K} of the basic factors f₁, . . . , f_{K} from the ground truth values y₁*, . . . , y_{K}* are rated by means of a first predetermined loss function 11.

In step 150, parameters 2a that characterize the behavior of the encoder network 2 and parameters 6a-9a that characterize the behavior of the factor classification head networks 6-9 are optimized towards the goal that, when further factor training images 10 are processed, the rating 11a by the loss function 11 is likely to improve. The finally trained states of the parameters 2a and 6a-9a are labelled with the reference signs 2a* and 6a*-9a*.

In step 160, classification training images 12 are provided. These classification training images 12 are labelled with ground truth combinations (a*, o*) of object values o* and attribute values a*.

In step 170, the encoder network 2, the object classification head network 3 and the attribute classification head network 4 map the classification training images 12 to combinations (a, o) of object values o and attributes a. Internally, this is done as follows: The encoder network 2 maps the classification training images 12 to representations Z. The association unit 5 decides which of the representation components z₁, . . . , z_{K} are relevant for the object classification and forwards a linear combination z₀ of these representation components z₁, . . . , z_{K} to the object classification head network 3, which then outputs the object value o. The association unit 5 also decodes which of the representation components z₁, . . . , z_{K} are relevant for the attributed classification and forwards a linear combination zₐ of these representation components z₁, . . . , z_{K} to the attribute classification head network 4, which then outputs the attribute value a.

In step 180, deviations of the so-determined combinations (a, o) from the respective ground truth combinations (a*, o*) are rated by means of a second predetermined loss function 13.

In step 190, at least parameters 3a that characterize the behavior of the object classification head network 3 and parameters 4a that characterize the behavior of the attribute classification head network 4 are optimized towards the goal that, when further classification training images 12 are processed, the rating 13a by the second loss function 13 is likely to improve. The finally trained states of the parameters 3a and 4a are labelled with the reference signs 3a* and 4a*.

According to block 191, a combined loss function 14 may be formed as a weighted sum of the first loss function 11 and the second loss function 13. According to block 192, the parameters 2a, 3a, 4a, 6a, 7a, 8a,9a that characterize the behaviors of all networks 2, 3, 4, 6, 7, 8, 9 may be optimized with the goal of improving the value of this combined loss function 14.

What is claimed is:

1. A method for training or pre-training an image classifier for classifying an input image with respect to combinations of an object value and an attribute value, the image classifier including an encoder network configured to map the input image to a representation which includes multiple independent components, an object classification head network configured to map the representation components of the input image to one or more of the object values, an attribute classification head network that is configured to map the representation components of the input image to one or more of the attribute values, and an association unit configured to provide, to each classification head network, a linear combination of those of the representation components of the input image that are relevant for a classification task of the respective classification head network, the method comprising the following steps:
providing, for each respective component of the representation, a factor classification head network that is configured to map the respective component to a predetermined basic factor of the input image;
providing factor training images that are labelled with ground truth values with respect to the basic factors represented by the components;
mapping, by the encoder network and the factor classification head networks, the factor training images to values of the basic factors;
rating deviations of the mapped values of the basic factors from the ground truth values using a first predetermined loss function; and
optimizing parameters that characterize a behavior of the encoder network and parameters that characterize a behavior of the factor classification head networks towards the goal that, when further factor training images are processed, a rating by the first loss function is likely to improve.

2. The method of claim 1, wherein the providing of the factor training images includes:
applying, to at least one given starting image, image processing that impacts at least one basic factor, thereby producing a factor training image; and
determining the ground truth values with respect to the basic factors based on the applied image processing.

3. The method of claim 1, wherein, in each factor training image, each basic factor takes a particular value, and the factor training images include at least one factor training image for each combination of values of the basic factors.

4. The method of claim 1, further comprising:
providing classification training images that are labelled with ground truth combinations of object values and attribute values;
mapping, by the encoder network, the object classification head network and the attribute classification head network, the classification training images to combinations of object values and attribute values;
rating deviations of the mapped combinations of object values and attribute values from the respective ground truth combinations using a second predetermined loss function; and
optimizing at least parameters that characterize a behavior of the object classification head network and parameters that characterize a behavior of the attribute classification head network towards the goal that, when further classification training images are processed, the rating by the second loss function is likely to improve.

5. The method of claim 4, wherein combinations of one encoder network on the one hand and multiple different combinations of an object classification head network and an attribute classification head network on the other hand are trained based on the same training of the encoder network with factor training images.

6. The method of claim 4, wherein:
a combined loss function is formed as a weighted sum of the first loss function and the second loss function; and
the parameters that characterize behaviors of all networks are optimized with a goal of improving a value of the combined loss function.

7. The method of claim 4, wherein the classification training images include images of road traffic situations.

8. The method of claim 7, wherein the basic factors that correspond to the components of the representation include one or more of:
a time of day in which the input image is acquired;
lighting conditions in which the input image is acquired;
a season of a year in which the input image is acquired; and
weather conditions in which the input image is acquired.

9. An image classifier for classifying an input image with respect to combinations of an object value and an attribute value, comprising:
an encoder network configured to map the input image to a representation, the representation including multiple independent components;
an object classification head network configured to map the representation components of the input image to one or more object values;
an attribute classification head network configured to map the representation components of the input image to one or more attribute values; and
an association unit configured to provide, to each respective classification head network, a linear combination of those of the representation components of the input image that are relevant for a classification task of the respective classification head network.

10. The image classifier of claim 9, wherein the encoder network is trained to produce a representation whose components each contain information related to one predetermined basic factor of the input image x.

11. The image classifier of claim 10, wherein at least one predetermined basic factor is one of:
a shape of at least one object in the input image;
a color or at least one object in the input image and/or area of the input image;
a lighting condition in which the input image was acquired; and
a texture pattern of at least one object in the input image.

12. The image classifier of claim 11, wherein the attribute value is a color or a texture of the object.

13. A non-transitory storage medium on which is stored a computer program for training or pre-training an image classifier for classifying an input image with respect to combinations of an object value and an attribute value, the image classifier including an encoder network configured to map the input image to a representation which includes multiple independent components, an object classification head network configured to map the representation components of the input image to one or more of the object values, an attribute classification head network that is configured to map the representation components of the input image to one or more of the attribute values, and an association unit configured to provide, to each classification head network, a linear combination of those of the representation components of the input image that are relevant for a classification task of the respective classification head network, the computer program, when executed by one or more computer, causes the one or more computers to perform the following steps:
providing, for each respective component of the representation, a factor classification head network that is configured to map the respective component to a predetermined basic factor of the input image;
providing factor training images that are labelled with ground truth values with respect to the basic factors represented by the components;
mapping, by the encoder network and the factor classification head networks, the factor training images to values of the basic factors;
rating deviations of the mapped values of the basic factors from the ground truth values using a first predetermined loss function; and
optimizing parameters that characterize a behavior of the encoder network and parameters that characterize a behavior of the factor classification head networks towards the goal that, when further factor training images are processed, a rating by the first loss function is likely to improve.

14. One or more computers configured to train or pre-train an image classifier for classifying an input image with respect to combinations of an object value and an attribute value, the image classifier including an encoder network configured to map the input image to a representation which includes multiple independent components, an object classification head network configured to map the representation components of the input image to one or more of the object values, an attribute classification head network that is configured to map the representation components of the input image to one or more of the attribute values, and an association unit configured to provide, to each classification head network, a linear combination of those of the representation components of the input image that are relevant for a classification task of the respective classification head network, the one or more computers configured to:
provide, for each respective component of the representation, a factor classification head network that is configured to map the respective component to a predetermined basic factor of the input image;
provide factor training images that are labelled with ground truth values with respect to the basic factors represented by the components;
map, by the encoder network and the factor classification head networks, the factor training images to values of the basic factors;
rate deviations of the mapped values of the basic factors from the ground truth values using a first predetermined loss function; and
optimize parameters that characterize a behavior of the encoder network and parameters that characterize a behavior of the factor classification head networks towards the goal that, when further factor training images are processed, a rating by the first loss function is likely to improve.
